(19) United States
(12) Patent Application Publication
(10) Pub. No.: US 2024/0089180 A1
(43) Pub. Date: Mar. 14, 2024

(54) BACKWARD COMPATIBILITY IN A FEDERATED DATA CENTER

(71) Applicant: VMware, Inc., Palo Alto, CA (US)

(72) Inventors: Sukhdev SINGH, Palo Alto, CA (US); Suresh MUPPALA, Palo Alto, CA (US); Amarnath PALAVALLI, Fremont, CA (US); Josh DORR, Palo Alto, CA (US); Pavlush MARGARIAN, Palo Alto, CA (US)

(21) Appl. No.: 17/931,523

(22) Filed: Sep. 12, 2022

(51) Int. Cl. H04L 41/342; H04L 41/0859; H04L 41/40

(52) U.S. Cl. CPC H04L 41/342; H04L 41/0859; H04L 41/40

(57) ABSTRACT

The disclosure provides an approach for backward compatibility of federated data centers. A method includes of synchronizing an object configuration includes creating an object at a global network manager, where the object is associated with one or more properties, and where each of the one or more properties is associated with a minimum virtualized networking version. The method includes determining at the global network manager a minimum compatibility version of the object that is a largest minimum virtualized networking version associated with the one or more properties. The method includes determining a span associated with the object, where the span includes one or more local network managers. The method includes, based on the minimum compatibility version and the span, synchronizing the object at each of the one or more local network managers or determining not to synchronize the object at each of the one or more local network managers.

### BACKGROUND

Software defined networking (SDN) may be used to create a software defined datacenter (SDDC). An SDDC involves a plurality of hosts in communication over a physical network infrastructure of a data center (e.g., on-premise data center or a cloud data center). Each host has one or more virtualized endpoints such as virtual machines (VMs), containers, or other virtual computing instances (VCIs). Though certain aspects are discussed herein with respect to VMs, it should be noted that the techniques may apply to other suitable VCIs as well.

Any arbitrary set of VMs in a datacenter may be placed in communication across a logical Layer 2 network by connecting them to a logical switch. A logical switch is collectively implemented by at least one virtual switch on each host that has a VM connected to the logical switch. Virtual switches provide packet forwarding and networking capabilities to virtual machines running on the host. The virtual switch on each host operates as a managed edge switch implemented in software by the hypervisor on each host.

SDN may provide an approach to network virtualization and security that extends across data centers, clouds and application frameworks. Networks can be provisioned and managed independent of underlying hardware. An entire network model can be reproduced in software, enabling any network topology—from simple to complex multitier networks—to be created and provisioned in seconds. Users can create multiple virtual networks with diverse requirements, leveraging a combination of the services—e.g., ranging from next—generation firewalls to performance management solutions—to build agile and secure environments. These services can then be extended to a variety of endpoints within and across clouds. An SDN network virtualization and security platform may offer services including, but not limited to, switching, routing, load balancing, virtual routing and forwarding (VRF), distributed firewalling, micro-segmentation, automated security policy recommendations and monitoring of traffic flows, gateway for bridging between virtual local area networks (VLANs) on the physical network and overlay networks, virtual private networking (VPN), federation, container networking and security, multi-cloud network and security, and an application programming interface (API) for integration with cloud management platforms.

Federation provides a centralized policy configuration and enforcement across multiple locations, enabling network-wide consistent policy, operational simplicity, and simplified disaster recovery architecture. In some embodiments, a global network manager federates—e.g., provides a centralized policy intent configuration for multiple local network managers of several datacenters in a federation environment. Each of the datacenters may be associated with a local network manager. The local network manager is a network manager in charge of network and security services for a data center. A network manager may provide a web-based user interface for managing the virtualized networking environment and also host an API server that processes API calls. The network manager user interface may be used to create objects including, but not limited to, segment, Tier-1 (T₁) gateway, Tier-0 (T0) gateway, Group, Security Policy, Rule, Gateway firewall, Logical switch, Tier-1 logical router, Tier-0 logical router, NSGroup, IP Sets, MAC Sets, Firewall section, Firewall rule, and Edge firewall objects.

In a federation environment, a tunnel end point (TEP) is the Internet protocol (IP) address of a transport node (e.g., edge node or a host) used for packet encapsulation within a location; and a remote tunnel end point (RTEP) is the IP address of a transport node (e.g., edge node) used for packet encapsulation across locations.

When the global manager creates a networking object, the networking object can span one or more locations. A location corresponds to local network manager for a data base, which may be geographically remote locations. A local object spans only one location. A stretched object spans more than one location. Objects have associated regions. An object with a location region has a span of one location. An object with a global region has a span of all available locations (e.g., all locations that are connected to the global network manager). An object with a custom region has a span that includes a specified subset of all available locations.

When the global network manager creates, or updates, an object that spans multiple locations, the local network managers at those locations must be the same version as, or a newer version than the global network manager for the object to be pushed by the global network manager to the local network managers. Forward compatibility ensures that a new version of a network manager is compatible with any features supported by an older version. As used herein, the version may correspond to a software version of a network manager. If a local network manager is an earlier version than the global network manager, the local network manager may not support one or more features of a new version. In some cases, however, backward compatibility is desirable. For example, virtualized networking environments, including a global network manager, may be offered as a software-as-a-service (SaaS). With the SaaS offering, the global network manager in the cloud may be updated often without requiring updating the local network managers.

### SUMMARY

The technology described herein provides a method of synchronizing an object configuration. The method generally includes creating an object at a global network manager, where the object is associated with one or more properties, and where each of the one or more properties is associated with a minimum virtualized networking version. The method includes determining, at the global network manager, a minimum compatibility version of the object, where the minimum compatibility version is a largest minimum virtualized networking version associated with the one or more properties. The method includes determining a span associated with the object, where the span extends to the domains of one or more local network managers. The method includes, based on the minimum compatibility version and the span, synchronizing the object at each of the one or more local network managers or determining not to synchronize the object at each of the one or more local network managers.

Further embodiments include a non-transitory computer-readable storage medium storing instructions that, when executed by a computer system, cause the computer system to perform the method set forth above, and a computer system including at least one processor and memory configured to carry out the method set forth above.

### BRIEF DESCRIPTION OF THE DRAWINGS

FIG. 1 depicts a block diagram of an example data center, according to one or more embodiments.

FIG. 2 depicts an example workflow for ensuring backward compatibility in a federated data center, according to one or more embodiments.

FIG. 3 depicts an example global manager and object configuration pushed to spanned local network managers, according to one or more embodiments.

FIG. 4 depicts an example global manager and object configuration pushed to spanned local network managers, according to one or more embodiments.

### DETAILED DESCRIPTION

The present disclosure provides an approach for backward compatibility in a federated software defined data center (SDDC) environment. Embodiments enable support of older local network managers with a newer global network manager, while maintaining consistency of object configuration between the global network manager and local network managers. The consistency provides that a feature associated with the object will function with expected behavior across the local network managers irrespective of the version of the local network manager.

In some embodiments, when an object configuration is created or modified on the global network manager, the object configuration is pushed (e.g., replicated and synced) to one or more local network managers based on the span of the object. In some embodiments, an object is associated with one or more properties. The object configuration may correspond to the properties and/or property values associated with the object. In some embodiments, the global network manager is updated with one or more new objects and/or one or more existing objects are modified with one or more new properties and/or new property values, and/or one or more existing properties and/or property values are modified. In some embodiments, the object configuration is specified by an intent. In some embodiments, the configuration/intent is specified by a user or administrator.

In some embodiments, before synchronizing the object configuration to the spanned local network managers, the global network manager determines a minimum compatibility version (MCV) of the object configuration based on the versions associated with the one or more properties or attributes of the object configuration. For example, the MCV may be the minimum version required of a local manager to support the object configuration. For example, the MCV required of a local manager to support the object configuration is the highest version required of a local manager to support all the properties or attributes of the object configuration, where each property or attribute is associated a minimum version required of a local manager to support that property or attribute and, therefore, the MCV of the object configuration is a highest one of the minimum versions associated with the properties or attributes of the object configuration. Accordingly, the MCV is dependent on the specified properties and/or property values of the object configuration and may change when the object is updated/modified.

In some embodiments, objects may have a hierarchical relationship. For example, a parent object may have one or more child objects. In this, the MCV of the parent object also depends on the MCV of the child objects. That is, the MCV for the parent object may be the highest version required to support the parent object configuration and the child object configurations. In some embodiments, the MCV associated with the object configuration is equal to or less than the global network manager version. After determining the MCV of the object configuration, the global network manager stores (e.g., in memory and/or persisted to the disk) the MCV for each intent object configuration when the object is created and/or updated/modified.

In some embodiments, before synchronizing an object configuration to the spanned local network managers, the global network manager validates the MCV of the object configuration against the local network manager version(s). In embodiments, the global network manager first determines whether validation of the MCV of the object configuration is needed. For example, the global network manager determines whether the version of each of the spanned local network managers is equal to or higher than the version of the global network manager. If so, the global network manager can skip validation of the MCV of the object configuration. That is, it may be assumed that later/higher versions of the network manager support all features, properties, attributes, functionality, and/or objects supported by earlier/lower versions of the network manager. Accordingly, if all of the local network managers have a version equal to or higher than the version of the global network manager, the global network manager can assume that any object configuration supported by the global network manager is also compatible with all of the local network managers. On the other hand, when one or more of the local network managers has a version that is lower than the version of the global network manager, then the global network manager performs validation of the object configuration with the local network managers.

In some embodiments, the global network manager determines whether validation is needed (1) when the object configuration is created or updated/modified and needs to synchronized to the spanned local network managers and (2) when the object is stretched to a new domain, i.e., when one or more local network managers are added to the span of the object configuration and the object configuration needs to be synchronized to the additional spanned local network manager(s).

In some embodiments, to validate the object configuration, the global network manager determines whether the version of each of the spanned local network managers is equal to or higher than the MCV required by the object configuration to ensure that the object configuration is compatible with each of the local network managers.

In some embodiments, the object configuration is valid when the MCV required by the object configuration is equal to lower than the versions of each of the spanned local network managers. In this case, the object configuration can be pushed to the local network managers corresponding to the span of the object.

In some embodiments, the object configuration is invalid when the MCV required by the object configuration is higher than the version of one or more of the spanned local network managers. In some embodiments, when the object configuration is invalid, the object configuration can be modified in effort to create a valid object configuration. For example, the global network manager may remove, or modify, one or more properties and/or property values of the object configuration that are associated with a manager version that is higher than the one or more local network managers, such that the MCV required by the modified object configuration will be equal to or lower than the version of the one or more local network managers and the object configuration will be valid. In this case, the modified object configuration can then be pushed to the spanned local network managers. In some embodiments, when the object configuration is invalid, and cannot be modified such that it becomes valid, the object configuration is rejected and the synchronization is aborted. In some embodiments, the global network manager reports an associated error message to the user indicating the object configuration is invalid. In some embodiments, the validation error message indicates the MCV of the object configuration and may identify the properties and/or property values of the object configuration causing the object configuration to be incompatible with the local network managers associated with the object's span. In this case, the user may specify the modifications to the object configuration to remove incompatible properties or property values or update the local network managers that lack support for the object's configuration.

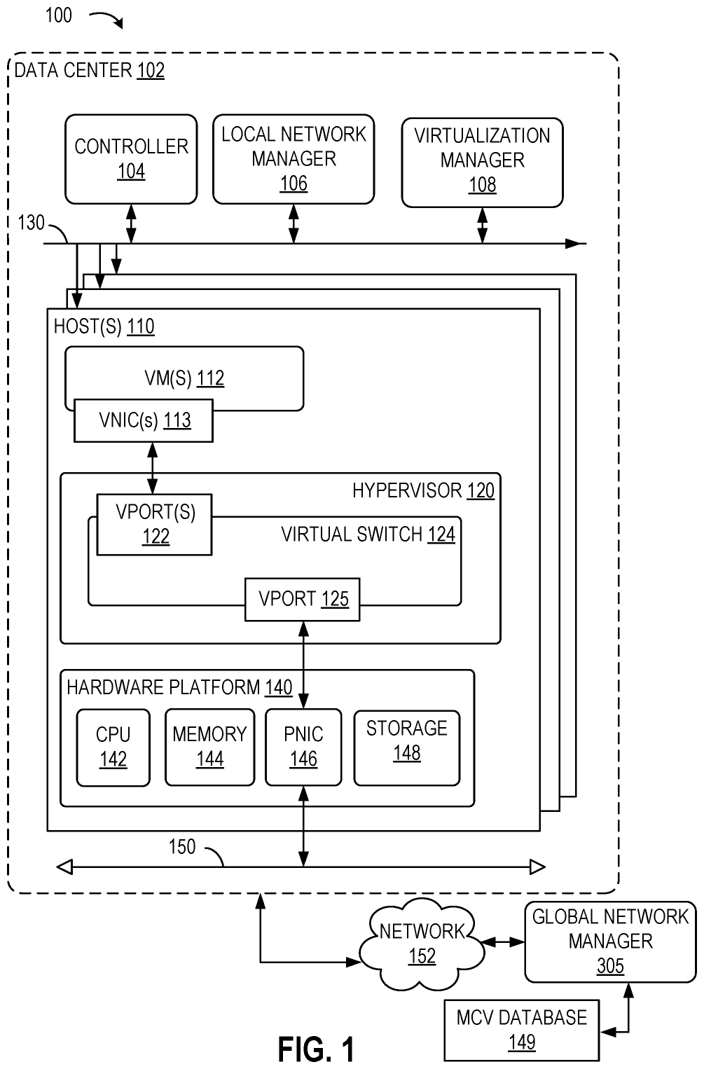

FIG. 1 depicts example physical and virtual network components in a networking environment 100 in which embodiments of the present disclosure may be implemented. Networking environment 100 includes a set of networked computing entities, and may implement a logical overlay network. Networking environment 100 includes a data center 102 and an external network 152, which may be a wide area network (WAN) such as the Internet.

Data center 102 includes hosts 110, a management network 130, a data network 150, a controller 104, a local network manager 106, and a virtualization manager 108. Data network 150 and management network 130 may be implemented as separate physical networks or separate virtual local area networks (VLANs) on the same physical network. Data center 102 includes a management plane and a control plane. The management plane and control plane each may be implemented as single entities (e.g., applications running on a physical or virtual compute instance), or as distributed or clustered applications or components. In alternative embodiments, a combined manager/controller application, server cluster, or distributed application, may implement both management and control functions. In the embodiment shown, network manager 106 at least in part implements the management plane and controller 104 at least in part implements the control plane

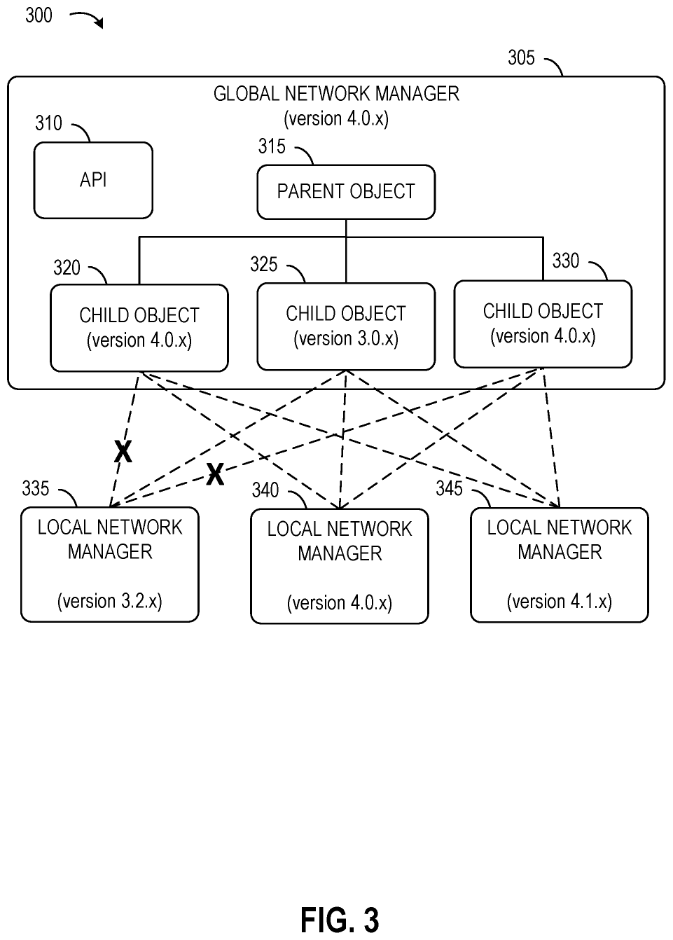

Local network manager 106 receives network configuration input from an administrator and generates desired state data that specifies how a logical network should be implemented in the physical infrastructure of the data center. Local network manager 106 communicates with host(s) 110 via management network 130. As used herein, the local network manager 106 may be a local network manager in a federated environment with a global network manager, further described below with reference to FIG. 3.

The control plane determines the logical overlay network topology and maintains information about network entities such as logical switches, logical routers, and endpoints, etc. The logical topology information is translated by the control plane into network configuration data that is then communicated to network elements of host(s) 110. Controller 104 generally represents a control plane that manages configuration of VMs 112 within the data center. Controller 104 may be one of multiple controllers executing on various hosts in the data center that together implement the functions of the control plane in a distributed manner. Controller 104 may be a computer program that resides and executes in a central server in the data center or, alternatively, controller 104 may run as a virtual appliance (e.g., a VM) in one of hosts 110. Although shown as a single unit, it should be understood that controller 104 may be implemented as a distributed or clustered system. That is, controller 104 may include multiple servers or virtual computing instances that implement controller functions. It is also possible for controller 104 and network manager 106 to be combined into a single controller/manager. Controller 104 collects and distributes information about the network from and to endpoints in the network. Controller 104 is associated with one or more virtual and/or physical CPUs (not shown). Processor(s) resources allotted or assigned to controller 104 may be unique to controller 104, or may be shared with other components of the data center. Controller 104 communicates with hosts 110 via management network 130, such as through control plane protocols. In some embodiments, controller 104 implements a central control plane (CCP).

Local network manager 106 and virtualization manager 108 generally represent components of a management plane comprising one or more computing devices responsible for receiving logical network configuration inputs, such as from a network administrator, defining one or more endpoints (e.g., VCIs) and the connections between the endpoints, as well as rules governing communications between various endpoints. In one embodiment, local network manager 106 is a computer program that executes in a central server in networking environment 100, or alternatively, local network manager 106 may run in a VM, e.g. in one of hosts 110. Local network manager 106 is configured to receive inputs from an administrator or other entity, e.g., via a web interface or API, and carry out administrative tasks for the data center, including centralized network management and providing an aggregated system view for a user.

In an embodiment, virtualization manager 108 is a computer program that executes in a central server in the data center (e.g., the same or a different server than the server on which network manager 106 executes), or alternatively, virtualization manager 108 runs in one of VMs 112. Virtualization manager 108 is configured to carry out administrative tasks for the data center, including managing hosts 110, managing VMs running within each host 110, provisioning VMs, transferring VMs from one host to another host, transferring VMs between data centers, transferring application instances between VMs or between hosts 110, and load balancing among hosts 110 within the data center. Virtualization manager 108 takes commands as to creation, migration, and deletion decisions of VMs and application instances on the data center. However, virtualization manager 108 also makes independent decisions on management of local VMs and application instances, such as placement of VMs and application instances between hosts 110. In some embodiments, virtualization manager 108 also includes a migration component that performs migration of VMs between hosts 110, such as by live migration.

Host(s) 110 may be communicatively connected to data network 150 and management network 130. Data network 150 and management network 130 are also referred to as physical or “underlay” networks, and may be separate physical networks or the same physical network as discussed. As used herein, the term “underlay” may be synonymous with “physical” and refers to physical components of networking environment 100. As used herein, the term “overlay” may be used synonymously with “logical” and refers to the logical network implemented at least partially within networking environment 100.

Host(s) 110 may be geographically co-located servers on the same rack or on different racks in any arbitrary location in the data center. Host(s) 110 are configured to provide a virtualization layer, also referred to as a hypervisor 120, that abstracts processor, memory, storage, and networking resources of a hardware platform 140 into multiple VMs.

Host(s) 110 may be constructed on a server grade hardware platform 140, such as an x86 architecture platform. The hardware platform 140 of a host 110 may include components of a computing device such as one or more processors (CPUs) 142, system memory 144, one or more network interfaces (e.g., PNICs 146), storage 148, and other components (not shown). A CPU 142 is configured to execute instructions, for example, executable instructions that perform one or more operations described herein and that may be stored in the memory and storage system. The network interface(s) enable host 110 to communicate with other devices via a physical network, such as management network 130, data network 150, and/or external network 152.

In some embodiments, storage 148 includes an MCV database 149. The MCV database 149 stores an MCV for each object configuration associated with a global network manager

Hypervisor 120 includes virtual switch 124. Virtual switch 124 has one or more virtual ports 122 that connect to one or more physical network interface cards (PNICs) 146. Virtual switch 124 has one or more virtual ports 122 that connect to one or more virtual NICs (VNICs) 113 of VMs 112.

VNIC(s) 113 are responsible for processing packets communicated between the VM 112 and virtual switch 124. VNICs may be, in some cases, a software implementation of a physical NIC. It should be understood that transfer of packets from one component to another in a system may involve simply passing a pointer or descriptor of a packet to a called routine.

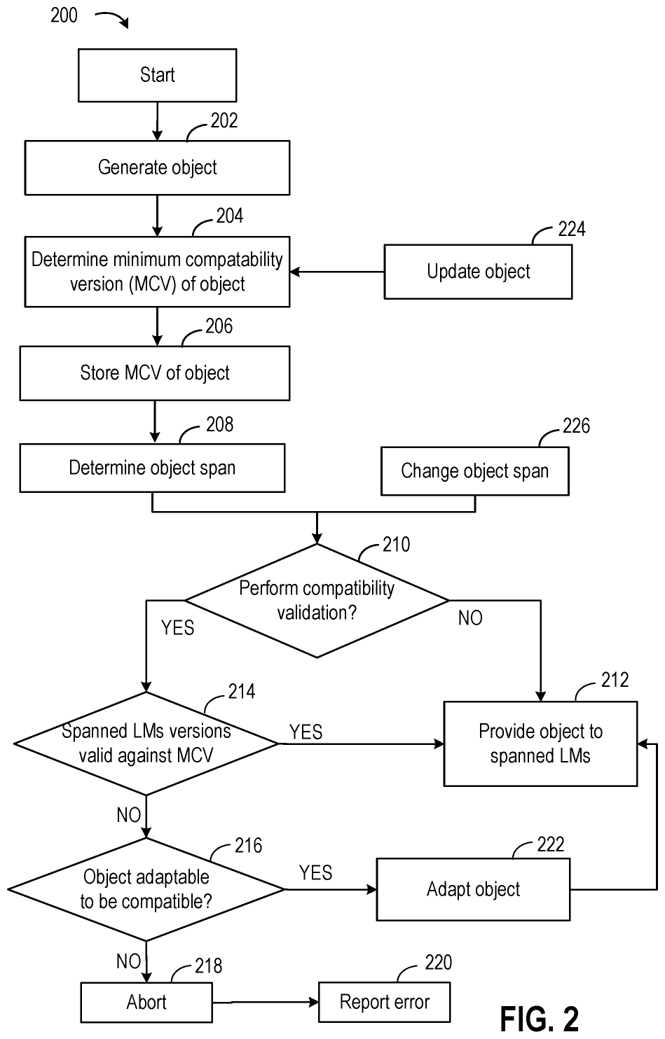

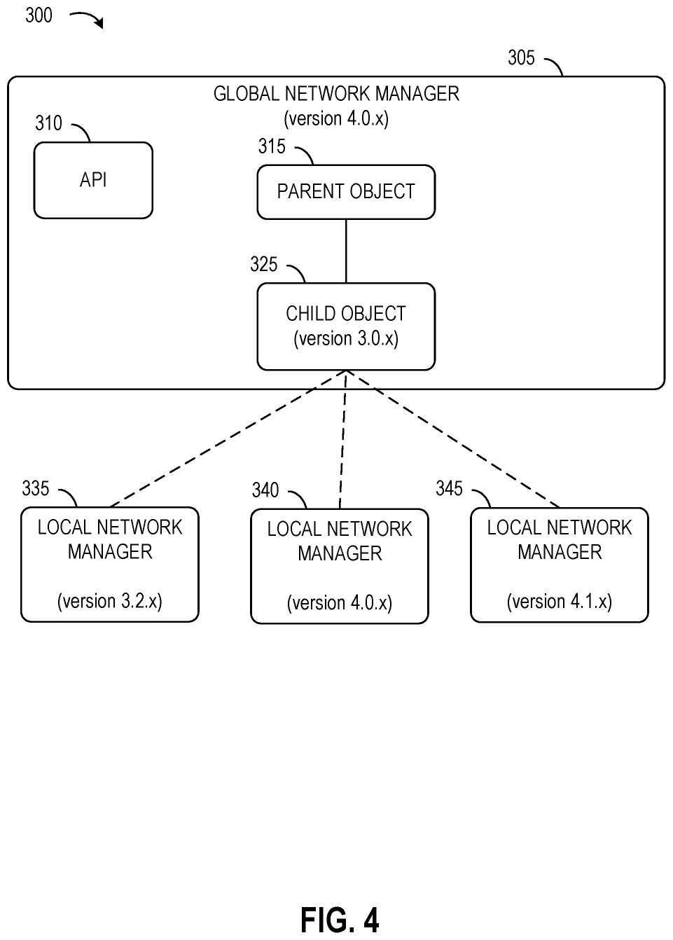

FIG. 2 depicts an example workflow with operations 200 for ensuring backward compatibility in a federated data center, according to one or more embodiments. In some embodiments, the operations 200 are performed by a global network manager. The operations 200 may be understood with reference to the FIGS. 3-4. In some embodiments, the operations 200 may be performed by the global network manager 305 illustrated in FIGS. 3-4.

Operations 200 may begin, at operation 202, with the global network manager obtaining a generated or updated object configuration. In some embodiments, an API of the global network manager is invoked to generate an object configuration. For example, a user or administrator may specify an object configuration intent via the global network manager API. In some embodiments, the global network manager API is a policy API. In the example illustrated in FIG. 3, the global network manager 305 invokes API 310 and obtains parent object 315 with child object 320, child object 325, and child object 330. In some embodiments, parent object 315 is a global object. One illustrative example of a global object is a global infrastructure object, such as an object for a TO gateway. In this example, each of the child objects 320, 325, and 330 may be associated with a TO configuration. In some embodiments, the object configuration obtained at operation 202 is a newly created object. In some embodiments, specifying the newly created object includes specifying one or more properties of the object and/or specifying one or more property values of the object properties. In some embodiments, the object configuration is specified by an intent. In some embodiments, the object configuration intent is specified by a user or administrator.

At operation 204, the global network manager determines the MCV of the object obtained at operation 202. According to embodiments of the present disclosure, the MCV is based on the network manager versions associated with one or more properties and/or property values of the object configuration. Software products are conventionally released with version numbers that increase for later versions of the same software program such that “version 2” of a software program is released after version 1 of the same software was released. Therefore, the term “higher version number” means “later release” and “lower version number” means “earlier release.” In some embodiments, the MCV is an earliest version of network manager software (i.e., the network manager software having the lowest version number) that supports the object configuration. The network manager software supports the object's configuration when it supports all of the properties and property values specified by the object configuration. In some embodiments, a parent object's MCV might be dependent on the MCV of child objects. In this case, the parent's MCV will be the highest MCV among the child objects. In some deployments, the MCV associated with the object configuration can be assumed to always be equal to or less than the global network manager version, for example, because the global network manager is kept up to date with a latest version, while the local network managers may be of an earlier version. As shown in the example illustrated in FIG. 3, the global network manager 305 is implemented using version 4.0.x of the global network manager software. Child object 320 requires at least version 4.0.x of the network manager software, the child object 325 requires version 3.0.x, and the child object 330 requires version 4.0.x. In this example, global network manager 305 determines the MCV of parent object 315 to be version 4.0.x because 4.0.x is the highest version number among all the version numbers associated with child objects 320, 325, 330 of parent object 315.

At operation 206, the global network manager stores the MCV of the object. As shown in FIG. 1, global network manager 305 may store the MCV in MCV database 149 containing the MCV of each object associated with the global network manager. As shown in FIG. 1, global network manager 305 has access to MCV database 149. It should be understood that MCV database 149 may be stored in storage or memory on a same physical device as global network manager 305, a separate physical device, or in a shared storage.

At operation 208, the global network manager determines the span of the object. In some embodiments, the span of the object is configured or specified by the user or administrator and may be dependent on the region type of the object. The span of an object corresponds to the one or more local network managers (e.g., such as local network manager 106) designated for maintaining a state of the object configuration, e.g., because the object is stretched to or at least partially resides in the domain of the local network manager. The span of the object may be all or a subset of the local network managers associated with the global network manager. In the example illustrated in FIG. 3, parent object 315 is a global object spanning all of the local network managers 335, 340, 345 associated with global network manager 305. In this example, global network manager 305 therefore determines the span of parent object 315 as spanning local network manager 335, local network manager 340, and local network manager 345.

At operation 210, the global network manager determines whether to perform compatibility validation for the object. In some embodiments, the global network manager determines, at operation 210, whether the version of each of the spanned local network managers is equal to or higher than the version of the global network manager. In the example illustrated in FIG. 3, global network manager 305 determines whether the version of local network manager 335, local network manager 340, and local network manager 345 are equal to or higher than the version 4.0.x of the global network manager 305.

Where the global network manager determines, at operation 210, not to perform compatibility validation, e.g., the version of each of the spanned local network managers is equal to or higher than the version of the global network manager, then at operation 212, the global network managers pushes the object to the spanned local network managers.

Where the global network manager determines, at operation 210, to perform compatibility validation, e.g., the version of one or more of the spanned local network managers is lower than the version of the global network manager, then at operation 214, the global network manager determines whether each of the spanned local network managers is valid against the MCV of the object. For example, the global network manager determines, at operation 214, whether the version of each of the spanned local network managers is equal to or higher than the MCV of the object, determined at operation 204. In the example illustrated in FIG. 3, global network manager 305 determines whether the version of local network manager 335, local network manager 340, and local network manager 345 are equal to or higher than the version 4.0.x of the global network manager 305.

Where the global network manager determines, at operation 214, that all of the spanned local network managers are valid against the MCV of the object, then at operation 212 the object is replicated and synchronized at the local network managers.

Where the global network manager determines, at operation 214, that one or more of the spanned local network managers are invalid against the MCV of the object, then at operation 216 the global network manager determines whether the object configuration can be adapted to be compatible with the local network managers. In the example illustrated in FIG. 3, global network manager 305 determines the version 4.0.x of local network manager 335 is equal to the MCV 4.0.x, the version 3.0.x of than the local network manager 340 is lower than the MCV 4.0x, and the version 4.0.x of local network manager 345 is equal to the MCV 4.0.x. Accordingly, global network manager 305 determines that the object 315 is invalid.

Where the global network manager determines, at operation 216, that the object cannot be adapted to be compatible with the local network managers, then at operation 218 the object configuration is rejected and the synchronization is aborted.

At operation 220, the global network manager reports an associated error message to the user indicating the object configuration is invalid. In some embodiments, the validation error message indicates the MCV of the object configuration and/or identifies the properties and/or property values of the object configuration causing the object configuration to be incompatible with the one or more spanned local network managers. In this case, the user may specify the modifications to the object configuration.

Where the global network manager determines, at operation 216, that the object can be adapted to be compatible with the local network managers, then at operation 222 the object configuration is adapted. For example, the object configuration can be modified in an effort to create a valid object configuration. In some embodiments, the global network manager removes, or modifies, one or more properties and/or property values of the object configuration that are associated with a version that is higher than the one or more local network managers, such that the MCV of the modified object configuration will be equal to or lower than the version of the one or more local network managers and the object configuration will be valid. In the example illustrated in FIG. 3, global network manager 305 can modify the object 315 configuration by removing the child object 320 and the child object 330 requiring the version 4.0.x as shown in FIG. 4. Accordingly, the MCV of the modified object 315 is 3.0.x, which is supported by the version 4.0.x of local network manager 335, the version 3.0.x of the local network manager 340, and the version 4.0.x of local network manager 345. Accordingly, the modified object 315 is valid.

At operation 212, the modified object can then be pushed to the spanned local network managers.

Where the object is updated, at operation 224, the MCV of the updated object is determined, at 204, and the operations 206-222 can be repeated to determine whether the updated object is valid with the spanned local network managers and synchronize the updated object to the local network managers. In some embodiments, modification of the existing object includes adding one or more new properties to the existing object, adding one or more new property values to existing properties of the existing object, and/or adjusting one or more existing properties and/or one or more existing property values of the existing object. In some embodiments, the object configuration is specified by an intent. In some embodiments, the object configuration is specified by a user or administrator.

Where the span of the object span is changed, at operation 226, the global network manager repeats the operations 210-222 to determine whether the object is compatible with all of the spanned local network managers. For example, object intent span may be stretched, i.e., when one or more local network managers are added to the span of the object configuration and the object configuration needs to be synchronized to the additional spanned local network managers.

The embodiments described herein provide a technical solution to a technical problem associated with backward compatibility in a federated data center environment. More specifically, implementing the embodiments herein allows for backward compatibility of older local network managers with newer global network managers.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of synchronizing an object configuration, the method comprising:
creating an object at a global network manager, wherein the object is associated with one or more properties, and wherein each of the one or more properties is associated with a minimum virtualized networking version;
determining at the global network manager a minimum compatibility version of the object, wherein the minimum compatibility version is a largest minimum virtualized networking version associated with the one or more properties;
determining a span associated with the object, wherein the span includes one or more local network managers; and
based on the minimum compatibility version and the span, synchronizing the object at each of the one or more local network managers or determining not to synchronize the object at each of the one or more local network managers.

2. The method of claim 1, further comprising:
determining to validate the minimum compatibility version of the object with respect to the span when a respective virtualized networking version of each respective local network manager of the one or more local network managers is equal to or higher than a virtualized networking version of the global network manager.

3. The method of claim 1, wherein based on the minimum compatibility version and the span, synchronizing the object at each of the one or more local network managers or determining not to synchronize the object at each of the one or more local network managers comprises:
synchronizing the object at each of the one or more local network managers when a respective virtualized networking version of each respective local network manager of the one or more local network managers is equal to or higher than the minimum compatibility version; or
adapting the object or determining not to synchronize the object at each of the one or more local network managers when the respective virtualized networking version of at least one local network manager of the one or more local network managers is lower than the minimum compatibility version.

4. The method of claim 3, wherein adapting the object comprises:
removing or modifying one or more properties of the object to reduce the minimum compatibility version of the object.

5. The method of claim 3, further comprising:
reporting an error message to a user or administrator upon determining not to synchronize the object at each of the one or more local network managers.

6. The method of claim 5, wherein the error message indicates the minimum compatibility version, the at least one local network manager, or a combination thereof.

7. The method of claim 1, further comprising:
updating the object at the global network manager;
determining at the global network manager a second minimum compatibility version of the updated object; and
based on the second minimum compatibility version and the span, synchronizing the updated object at each of the one or more local network managers or determining not to synchronize the updated object at each of the one or more local network managers.

8. The method of claim 1, further comprising:
updating the span of the object at the global manager, wherein the updated span includes one or more additional local network managers; and
based on the minimum compatibility version and the updated span, synchronizing the object at each of the one or more additional local network managers or determining not to synchronize the object at each of the one or more additional local network managers.

9. The method of claim 1, further comprising:
storing the minimum compatibility version.

10. The method of claim 1, wherein each of the one or more local network managers is associated with a different data center, and wherein the different data centers are federated by the global network manager.

11. A system comprising:
one or more processors; and
at least one memory, the one or more processors and the at least one memory configured to:
create an object at a global network manager, wherein the object is associated with one or more properties, and wherein each of the one or more properties is associated with a minimum virtualized networking version;
determine at the global network manager a minimum compatibility version of the object, wherein the minimum compatibility version is a largest minimum virtualized networking version associated with the one or more properties;
determine a span associated with the object, wherein the span includes one or more local network managers; and
based on the minimum compatibility version and the span, synchronize the object at each of the one or more local network managers or determining not to synchronize the object at each of the one or more local network managers.

12. The system of claim 11, wherein the one or more processors and the at least one memory are configured to:
determine to validate the minimum compatibility version of the object with respect to the span when a respective virtualized networking version of each respective local network manager of the one or more local network managers is equal to or higher than a virtualized networking version of the global network manager.

13. The system of claim 11, wherein the one or more processors and the at least one memory being configured to, based on the minimum compatibility version and the span, synchronize the object at each of the one or more local network managers or determine not to synchronize the object at each of the one or more local network managers comprises the one or more processors and the at least one memory being configured to:
synchronize the object at each of the one or more local network managers when a respective virtualized networking version of each respective local network manager of the one or more local network managers is equal to or higher than the minimum compatibility version; or
adapt the object or determine not to synchronize the object at each of the one or more local network managers when the respective virtualized networking version of at least one local network manager of the one or more local network managers is lower than the minimum compatibility version.

14. The system of claim 13, wherein the one or more processors and the at least one memory being configured to adapt the object comprises the one or more processors and the at least one memory being configured to:
remove or modify one or more properties of the object to reduce the minimum compatibility version of the object.

15. The system of claim 13, wherein the one or more processors and the at least one memory are configured to:
report an error message to a user or administrator upon determining not to synchronize the object at each of the one or more local network managers.

16. The system of claim 15, wherein the error message indicates the minimum compatibility version, the at least one local network manager, or a combination thereof.

17. The system of claim 11, wherein the one or more processors and the at least one memory are configured to:
update the object at the global network manager;
determine at the global network manager a second minimum compatibility version of the updated object; and
based on the second minimum compatibility version and the span, synchronize the updated object at each of the one or more local network managers or determine not to synchronize the updated object at each of the one or more local network managers.

18. The system of claim 11, wherein the one or more processors and the at least one memory are configured to:
update the span of the object at the global manager, wherein the updated span includes one or more additional local network managers; and
based on the minimum compatibility version and the updated span, synchronize the object at each of the one or more additional local network managers or determine not to synchronize the object at each of the one or more additional local network managers.

19. The system of claim 11, wherein the one or more processors and the at least one memory are configured to:
store the minimum compatibility version.

20. A non-transitory computer-readable medium comprising instructions that, when executed by one or more processors of a computing system, cause the computing system to perform operations for synchronizing an object configuration, the operations comprising:
creating an object at a global network manager, wherein the object is associated with one or more properties, and wherein each of the one or more properties is associated with a minimum virtualized networking version;
determining at the global network manager a minimum compatibility version of the object, wherein the minimum compatibility version is a largest minimum virtualized networking version associated with the one or more properties;
determining a span associated with the object, wherein the span includes one or more local network managers; and
based on the minimum compatibility version and the span, synchronizing the object at each of the one or more local network managers or determining not to synchronize the object at each of the one or more local network managers.
